(19) United States
(12) Patent Application Publication
(10) Pub. No.: US 2009/0122831 A1
(43) Pub. Date: May 14, 2009

(54) Intelligent flow/temperature measuring device

(75) Inventor: Bernie Chen, Sijhih City (TW)

Correspondence Address: BIRCH STEWART KOLASCH & BIRCH, PO BOX 747, FALLS CHURCH, VA, 22040-0747, US

(73) Assignee: EMA Electronics Corp.

(21) Appl. No.: 11/984,173

(22) Filed: Nov. 14, 2007

(51) Int. Cl. G01K 13/00

(52) U.S. Cl. 374/142; 374/E13.001

(57) ABSTRACT

An intelligent flow/temperature measuring device includes a circuit portion having a microcontroller unit, to which a temperature sensor, a flow sensor, a temperature display unit, and a flow display unit are connected, such that signals output by the temperature and flow sensors are transmitted to and processed by the microcontroller unit, and the processes data are separately displayed on the temperature and flow display units. The flow sensor includes a flow speed and a temperature sensing resistor, which are used to sense flow speed and temperature, respectively, and connected to the microcontroller unit via an A/D converting circuit each and to two inputs of a differential amplifying circuit. The differential amplifying circuit has an output connected via an A/D converting circuit and a filter circuit to the microcontroller unit. With these arrangements, the intelligent flow/temperature measuring device is more convenient for use.

### FIELD OF THE INVENTION

The present invention relates to a combined flow/temperature sensor, and more particularly to an intelligent flow/temperature measuring device.

### BACKGROUND OF THE INVENTION

In the currently available techniques, two independent products, namely, a flow sensor and a temperature sensor are required to separately measure the flow and the temperature of a fluid.

The flow sensor is used in a flow supervising system. When the fluid has a flow speed reaching a preset flow valve value, the flow sensor generates a measuring signal for protecting a chain safeguard system. The commonly used flow sensor is of a mechanical type, such as the traditional differential pressure flow sensor and float-type flow sensor. The mechanical type flow sensors are complicate, bulky, and uneasy to mount (because a pipe must be cut for installing the flow sensor), have big pressure loss and low sensing accuracy, and could be applied to measure the flow of only one of gas and liquid. The temperature sensor is used to display temperature and generate a control signal. A digital panel is provided on the temperature sensor for displaying the state of a key-set function menu.

The above-mentioned flow sensor and temperature sensor are most frequently used in automated systems. Most systems would use both of these sensors. Since the conventional temperature and flow sensors are two independent sensors, they would adversely complicate the system wiring and reduce system reliability, and inevitably bring inconveniences to a user in operating, maintaining, and installing the sensors. Moreover, it is a pity that most commonly used flow sensors and temperature sensors generally have a cylindrical or a rectangular body, and accordingly, a monotonous appearance.

It is therefore tried by the inventor to develop an intelligent flow/temperature measuring device to overcome the problems in the prior art flow and temperature sensors.

### SUMMARY OF THE INVENTION

A primary object of the present invention is to provide an intelligent flow/temperature measuring device that combines a flow sensor and a temperature sensor into one integral unit to thereby provide the functions of sensing and measuring both the flow and the temperature of a fluid.

To achieve the above and other objects, the intelligent flow/temperature measuring device according to a preferred embodiment of the present invention includes a circuit portion and a structure portion. The circuit portion has a microcontroller unit, to which a temperature sensor, a flow sensor, a temperature display unit, and a flow display unit are connected, such that signals output by the temperature and flow sensors are transmitted to and processed by the microcontroller unit, and the processes data are separately displayed on the temperature and flow display units.

The flow sensor includes a flow speed sensing resistor for sensing a flow speed, and a temperature sensing resistor for sense a temperature of a fluid and generating a reference voltage. The flow speed and the temperature sensing resistor are connected to the microcontroller unit and to two inputs of a differential amplifying circuit. The differential amplifying circuit has an output connected via a filter circuit to the microcontroller unit. The filter circuit is a band-pass filter.

The intelligent flow/temperature measuring device further includes a reference level generator for providing a reference level to the temperature sensing resistor. The reference level generator has an input connected to the microcontroller unit and another input connected to a voltage range control unit. The voltage range control unit is connected to the microcontroller unit to allow manually setting of a flow measuring range. The differential amplifying circuit is a differential amplifier.

The temperature sensor is provided with a filter circuit, which is connected to and between the temperature sensor and the microcontroller unit. The filter circuit is a band-pass filter.

The temperature display unit uses a digital panel to display a temperature value, and the flow display unit uses ten light emitting diodes (LEDs) to indicate a flow.

The structure portion of the intelligent flow/temperature measuring device includes a main body and a probe connected at a proximal end to the main body; and the temperature sensor and the flow sensor are mounted inside a distal end of the probe. The temperature sensor in the probe is enclosed by a type of thermal-conductive filler. The microcontroller unit, the temperature display unit, and the flow display unit are mounted in the main body. The main body is a spherical body having a front tangential surface, and the temperature display unit and the flow display unit are located at the front tangential surface of the main body. The probe has a diameter not larger than 10 mm.

As compared to the existing techniques, the intelligent flow/temperature measuring device of the present invention has the following advantages:
1. The intelligent flow/temperature measuring device combines the flow sensor and the temperature sensor into one integral unit to provide the functions of both flow and temperature sensors.
2. The intelligent flow/temperature measuring device provides accurate measuring results and is almost not affected by ambient temperature.
3. The intelligent flow/temperature measuring device allows a user to set the flow measuring range.
4. The probe of the intelligent flow/temperature measuring device may be installed on a small-sized pipe to reduce the complexity in measuring the flow and the temperature of a fluid.
5. The main body of the intelligent flow/temperature measuring device is a spherical body having a front tangential surface to give a beautiful and attractive appearance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein FIG. 1 is a block diagram of an intelligent flow/temperature measuring device according to a preferred embodiment of the present invention;

FIG. 2 is a front view of the intelligent flow/temperature measuring device of the present invention; and

FIG. 3 is a sectioned side view of the intelligent flow/temperature measuring device of the present invention.

### DETAILED DESCRIPTION OF THE PREFERRED EMBODIMENTS

Please refer to FIG. 1 that is a block diagram of an intelligent flow/temperature measuring device 10 according to a preferred embodiment of the present invention. The intelligent flow/temperature measuring device 10 of the present invention includes a structure portion and a circuit portion.

The circuit portion is installed inside the structure portion, and includes a microcontroller unit 13, to which a flow display unit 8, a temperature display unit 9, a temperature sensor 11, and a flow sensor 12 are electrically connected. Temperature signal and flow signal output by the temperature sensor 11 and the flow sensor 12, respectively, are transmitted to the microcontroller 13 for processing, and the processed temperature and flow data are displayed via the temperature display unit 9 and the flow display unit 8, respectively.

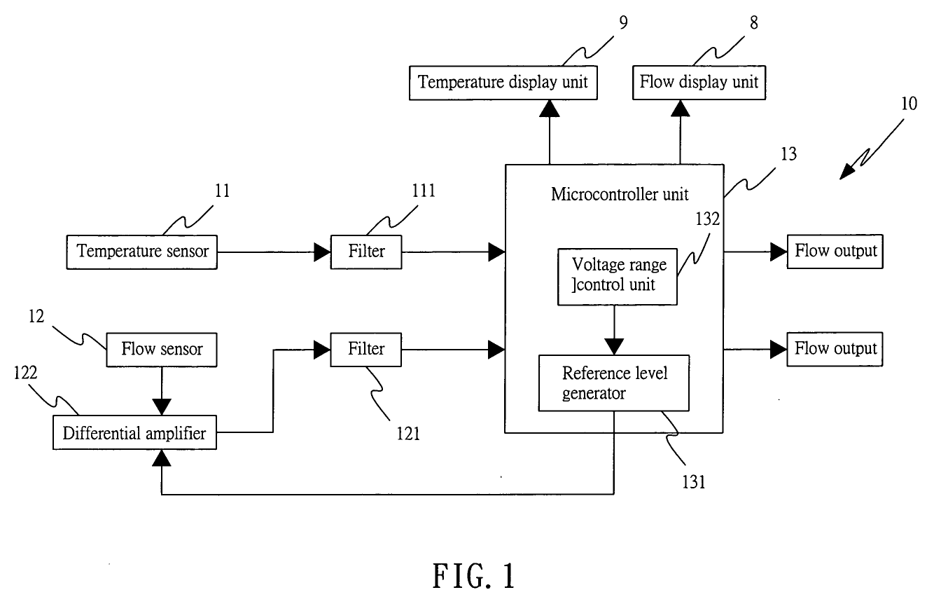

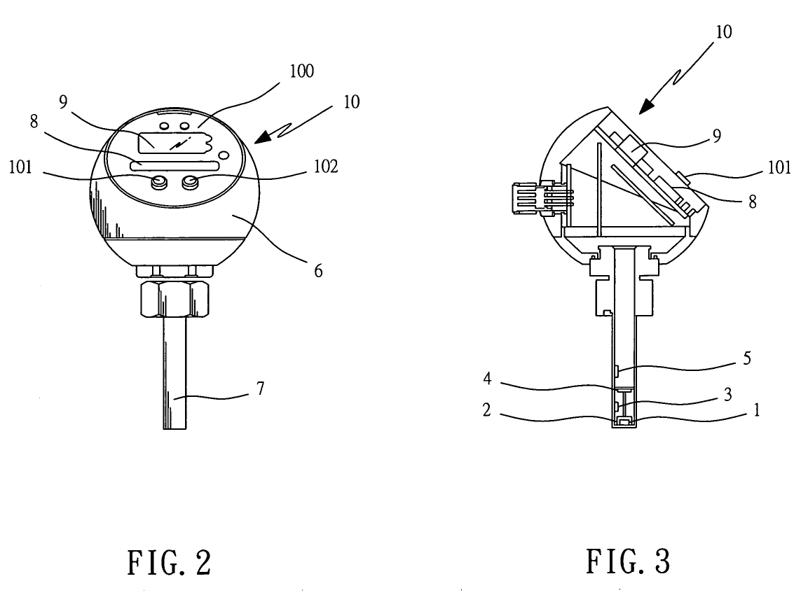

Please refer to FIGS. 2 and 3 that are front and sectioned side views, respectively, of the intelligent flow/temperature measuring device 10 according to the preferred embodiment of the present invention. The structure portion of the intelligent flow/temperature measuring device 10 includes a spherical main body 6 having a front tangential surface and a probe 7. The probe 7 is connected at a proximal end to the main body 6; and the temperature sensor 11 and the flow sensor 12 are mounted inside a distal end of the probe 7. The flow display unit 8, the temperature display unit 9, and the microcontroller unit 13 are mounted inside the main body 6. The flow display unit 8 and the temperature display unit 9 are located at the front tangential surface of the main body 6. The probe 7 has a diameter not larger than 10 mm, and being 8 mm in the preferred embodiment.

It is known a flow is measured based on the principle of thermal diffusion using the following theoretical formula:

V□Ksqrt(T);T□R_{T}

where,
V is fluid flow speed;
T is temperature; and
R_{T} is thermal resistor, of which resistance changes with changing temperature;

As can been found from the above theoretical formula, a temperature sensing resistor value is in direct proportion to the square of flow speed. Based on this principle, two resistors (for sensing temperature) are supplied with a constant voltage source. And, any voltage change detected by comparing a reference sensing resistor with a flow variation resistor is amplified and filtered to generate a flow measuring signal.

In the preferred embodiment of the present invention, the flow sensor 12 includes a flow speed sensing resistor 1 and a temperature sensing resistor 3 for sensing water temperature and generating a reference voltage. The temperature sensing resistor 3 is powered via a reference level generator 131. The flow sensing resistor 1 and the temperature sensing resistor 3 are separately connected to two inputs of a differential amplifier 122, which may be a currently commercially available product. Temperature and flow signals output from the differential amplifier 122 are filtered by band-pass filters 111 and 121, respectively. The band-pass filters 111, 121 may consist of currently commercially available high-pass filter circuit and low-pass filter circuit. The filtered signals are transmitted to the microcontroller unit 13. The microcontroller unit 13 (P89LPC512) may generate a reference level. The reference level generator 131 has an input connected to the microcontroller unit 13. The microcontroller unit 13 controls the high or low of the reference level to achieve the function of a voltage range control unit 132. A user may set a voltage output range for the reference level generator 131 via the microcontroller unit 13 to thereby obtain a flow measuring range.

The intelligent flow/temperature measuring device 10 of the present invention also includes a heating element 2 and a semiconductor 4, which are mounted inside the distal end of the probe 7 for maintaining a thermal balance in order to obtain a relatively wide linear range.

The temperature is measured using a currently commercially available digital temperature sensor LM37 and a thermal-conductive silica gel with high thermal conductivity, which provide increased sensitivity and accuracy in measuring temperature. The temperature sensor 11 has a digital temperature IC 5, which is mounted in the probe 7 above the flow sensor 12 and enclosed by the highly thermal-conductive silica gel, and is isolated from the flow sensor 12 by the semiconductor 4.

The digital temperature sensor LM37 is a serial type digital circuit, and internally includes a read-only memory (ROM). The microcontroller unit 13 reads out a value from the ROM and calculates a temperature value based on the read value. The temperature sensor 11 is provided with a band-pass filter 111.

The temperature display unit 9 uses a digital panel 100 to display a temperature value. The flow display unit 8 uses ten light emitting diodes (LEDs) to indicate a flow. The ten LEDs are arranged in a straight line. And, the number of lightened LEDs is in direct proportion to the size of the flow.

The microcontroller unit 13 (P89LPC512) is able to generate two supervising signals separately corresponding to the flow and the temperature. The signals may be output in different manners. The outputs may be divided into digital output and analog output according to the types of outputs. The digital output may be further divided into NPN type, PNP type, and relay type output. The analog output includes 4˜20 mAat 0˜10V. The output manners may be divided into two-wire system and three-wire system.

To use the intelligent flow/temperature measuring device 10 of the present invention, simply drill an 8 mmφ small aperture on a pipe transferring a target fluid to be measured, and insert the probe 7 into the pipe via the small aperture. In the case the target fluid to be measured is not transferred via a pipe; simply insert the probe 7 directly into the target fluid to be measured. The user may set high/low limits for a flow measuring by setting a flow range to be measured.

Please refer to FIG. 2. For setting the flow measuring range on the intelligent flow/temperature measuring device 10 of the present invention, the main body 6 is provided at a lower portion of the tangential surface with two laterally arranged keys. A left one of the two keys is MODE/ENTER key 101 for setting a function menu (not shown) and confirming a desired function. Each time the MODE/ENTER key is pushed, the function menu is scrolled in the digital panel 100. A right one of the two keys is LEARN/SET key 102 for setting different parameters on a corresponding function menu. The parameters are also shown on the digital panel 100. To confirm the parameter settings, simply push the MODE/ENTER key 101 again.

The present invention has been described with a preferred embodiment thereof and it is understood that many changes and modifications in the described embodiment can be carried out without departing from the scope and the spirit of the invention that is intended to be limited only by the appended claims.

1. temperature; the flow speed sensing resistor and the temperature sensing resistor being connected to two inputs of a differential amplifying circuit, which has an output connected via an A/D converting circuit and a filter circuit to the microcontroller unit.

2. The intelligent flow/temperature measuring device as claimed in claim 1, further comprising a reference level generator, the reference level generator having an input connected to the microcontroller unit and an output connected to the temperature sensing resistor for supplying a voltage to the temperature sensing resistor.

3. The intelligent flow/temperature measuring device as claimed in claim 2, further comprising a voltage range control unit, the voltage range control unit having an input connected to the microcontroller unit and an output connected to another input of the reference level generator for allowing manually setting of a flow measuring range.

4. The intelligent flow/temperature measuring device as claimed in claim 1, wherein the temperature sensor is further provided with a filter circuit, which is connected to and between the temperature sensor and the microcontroller unit.

5. The intelligent flow/temperature measuring device as claimed in claim 1, wherein the temperature display unit is a digital temperature display for displaying a temperature value, and the flow display unit includes ten LEDs for indicating a flow.

6. The intelligent flow/temperature measuring device as claimed in claim 1, further comprising a structure portion, the structure portion including a main body and a probe connected at a proximal end to the main body; and the temperature sensor and the flow sensor being mounted inside a distal end of the probe.

7. The intelligent flow/temperature measuring device as claimed in claim 6, further comprising a type of thermal-conductive filler provided in the probe around the temperature sensor; and wherein the microcontroller unit, the temperature display unit, and the flow display unit are mounted in the main body.

8. The intelligent flow/temperature measuring device as claimed in claim 6, wherein the main body is a spherical body having a front tangential surface, and the temperature display unit and the flow display unit are located at the front tangential surface of the main body; and wherein the probe has a diameter not larger than 10 mm.
